(19) United States
(12) Patent Application Publication
(10) Pub. No.: US 2012/0063487 A1
(43) Pub. Date: Mar. 15, 2012

(54) Ear Thermometer and Method for Measuring the Body Temperature

(75) Inventor: Andrej Albrecht, Stuttgart (DE)

(73) Assignee: Robert Bosch GmbH, Stuttgart (DE)

(21) Appl. No.: 13/233,775

(22) Filed: Sep. 15, 2011

(30) Foreign Application Priority Data
Sep. 15, 2010 (DE) 10 2010 040 777.1

(51) Int. Cl. G01J 5/00

(52) U.S. Cl. 374/128

(57) ABSTRACT

An ear thermometer with an infrared sensor, a control unit and a power supply unit in a housing has a wireless communication interface. The wireless communication interface is a WLAN or Bluetooth interface for communication with a base station, in which temperature measurement values are displayed and stored.

This application claims priority under 35 U.S.C. §119 to German patent application no. DE 10 2010 040 777.1, filed Sep. 15, 2010 in Germany, the disclosure of which is incorporated herein by reference in its entirety.

### BACKGROUND

The present disclosure relates to an ear thermometer and method for measuring the body temperature.

At the present time, the body temperature is usually measured for various purposes using simple digital thermometers or analog mercury thermometers. Temperature sensors are stuck onto the skin in hospitals, with the reliability being unsatisfactory. In the daily rhythm, the human body is subject to periodic temperature variations, with a temperature minimum, the basal temperature, being set whilst sleeping. Women using natural contraception methods rely upon identifying the basal temperature and measuring it precisely. In practical terms, this is brought about by always measuring the body temperature at the same time after a night-time sleeping phase, usually between 6 and 7 am. The required accuracy of the measurement can be achieved by measuring the thermal radiation from an eardrum.

US 2007191729 A1 discloses an ear thermometer with infrared sensor, data logging and an evaluation unit for measuring the temperature of an eardrum.

### SUMMARY

The ear thermometer according to the disclosure is advantageous in that the body temperature can be measured automatically without having to interrupt the sleep. Additionally, there is an improvement in the quality of the temperature data because no body movements are required. A further advantage is that the ear thermometer can be integrated into a hearing aid.

### BRIEF DESCRIPTION OF THE DRAWINGS

Exemplary embodiments of the disclosure are explained on the basis of the drawings, in which:

FIG. 1 shows a block diagram of an ear thermometer as per an embodiment of the present disclosure;

FIG. 2 shows a block diagram of a base station for an ear thermometer as per an embodiment of the present disclosure;

FIG. 3 shows a schematic illustration of an ear thermometer as per a further embodiment of the present disclosure on an ear; and

FIG. 4 shows a flowchart of the method as per an embodiment of the present disclosure.

### DETAILED DESCRIPTION

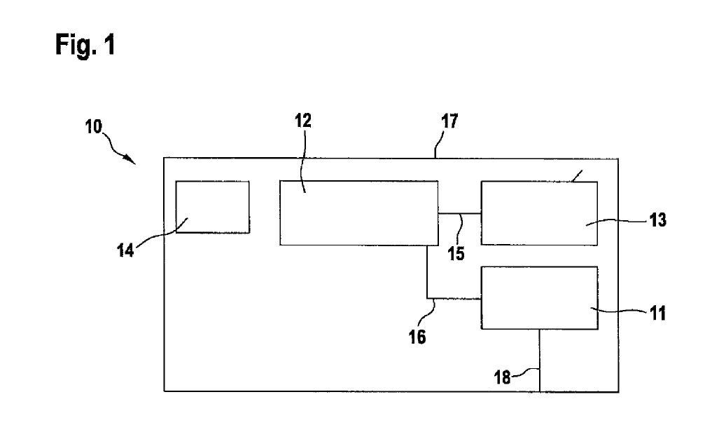

FIG. 1 illustrates an ear thermometer 10 as per an embodiment of the present disclosure. The ear thermometer 10 has an infrared sensor 11, a control unit 12, a wireless communication interface 13 and a power supply unit 14. The control unit 12 is connected to the infrared sensor 11 and the wireless communication interface 13 via data lines 15, 16. The power supply unit 14 supplies the control unit 12, the infrared sensor 11 and the wireless communication interface 13 with electric potential via connection lines (not shown). The infrared sensor 11, the control unit 12, the wireless communication interface 13 and the power supply unit 14 are arranged within a housing 17. The ear thermometer 10 has an optical waveguide 18, which is connected to the infrared sensor 11 and is routed out of the housing 17. In this example, the infrared sensor 11 is a thermopile. The wireless communication interface 13 is a WLAN or Bluetooth interface or a combined WLAN and Bluetooth interface.

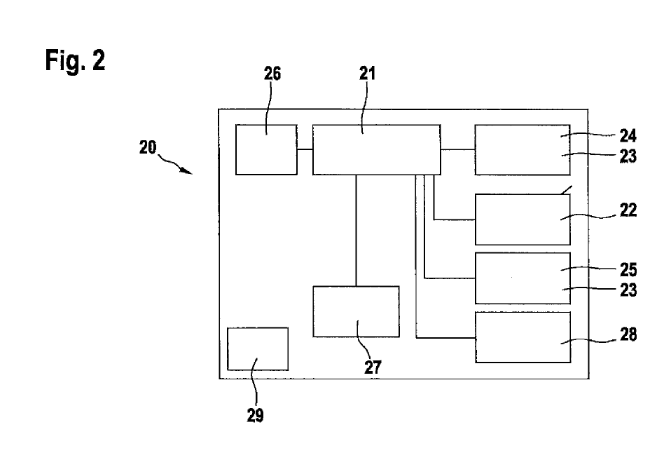

FIG. 2 shows a base station 20 for the ear thermometer 10 from FIG. 1 as per an embodiment of the present disclosure. The base station 20 has a base control unit 21, a wireless communication interface 22 and a human-machine interface 23 with a touchscreen display 24 and a loudspeaker 25. The touchscreen display 24 serves as an input and output device and the loudspeaker 25 serves as an alarm device. The base control unit 21 is connected to the wireless communication interface 22, the touchscreen display 24 and the loudspeaker 25 via data lines. The base station 20 furthermore has a clock 26, a data storage device 27 and a memory card interface 28, which are each connected to the base control unit 21. The memory card interface 28 can be used to transmit measurement values to a memory card. A power supply unit 29 supplies the components of the base station 20 with electric potential.

The data lines shown in FIG. 2 can be partly or wholly embodied as a data bus and combined.

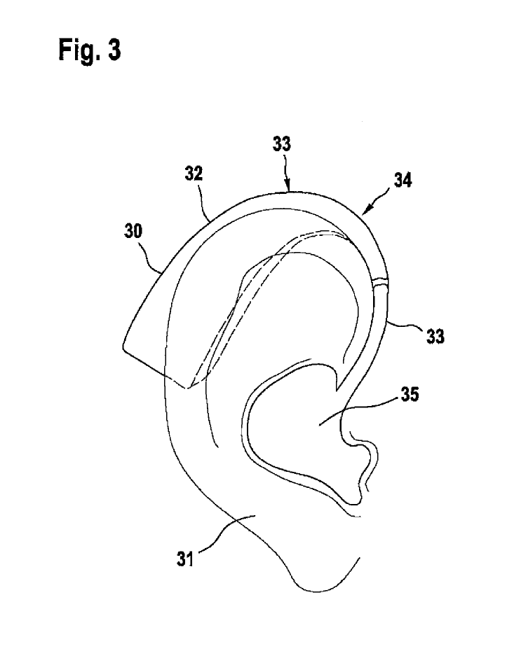

FIG. 3 shows, in respect of its geometric design, an ear thermometer 30 as per an embodiment of the present disclosure on an ear 31. The housing 32 contains the components of the ear thermometer 10 from FIG. 1 in a housing body, with the optical waveguide 18 from FIG. 1 in this case being routed, via a housing frame 34, as optical waveguide 33 to an ear mold 35, from which the optical waveguide 33 can receive the thermal radiation from the eardrum. The ear thermometer 30 geometry resembles that of a behind-the-ear hearing aid.

In a further embodiment, the ear thermometer is integrated into a hearing aid. This is possible not only in the case of behind-the-ear hearing aids but also in the case of in-the-ear hearing aids.

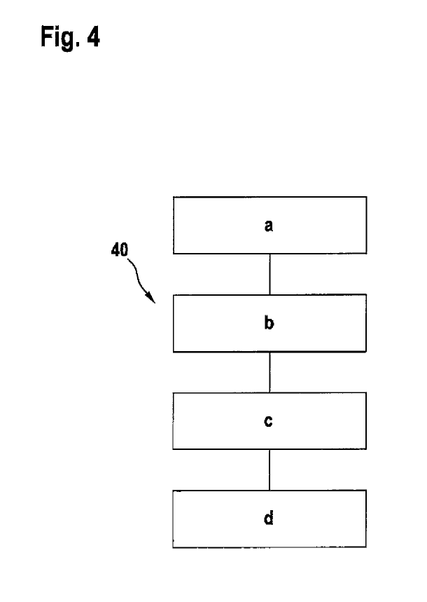

FIG. 4 shows a flowchart 40 of the method for measuring the body temperature of a human by means of an ear thermometer with an infrared sensor and a base station as per an embodiment of the present disclosure. For the explanation, reference is made to elements of the ear thermometer 10 in FIG. 1 and the base station in FIG. 2. The method starts with method step a) measuring an infrared sensor measurement value from the infrared sensor. Here, the infrared radiation from the eardrum is routed to the infrared sensor 11 via the optical waveguide 18 and converted into an infrared sensor measurement value at said sensor. This is followed by method step b) converting the infrared sensor measurement value into a temperature measurement value. In this case, this takes place in the ear thermometer in accordance with calibration data stored in the ear thermometer. Now a temperature measurement value is available in a usual temperature scale, e.g. in degrees Celsius. Now method step c) takes place: wirelessly transmitting the temperature measurement value to the base station 20 by means of appropriate wireless communication interfaces 13 and 22. This is subsequently followed by method step d) displaying and storing the temperature measurement value. The display 23 is used for the display and the data recording device 27 of the base station 20 is used for storage.

In an alternative embodiment, method steps b) and c) have been interchanged in the sense that the infrared sensor measurement value is firstly transmitted to the base station 20 by means of wireless communication interfaces 13 and 22 and a conversion into a temperature measurement value only takes place in the base station. Said temperature measurement value is then displayed and stored as described above.

A warning signal is emitted by the loudspeaker 25 if there is a fault in the communication between ear thermometer 10 and base station 20.

In a preferred embodiment of the disclosure, a timetable is entered via the human-machine interface 23 of the base station 20 and stored in the latter. The body temperature is measured automatically according to this timetable with the aid of the clock 26.

The ear thermometer according to the disclosure can be used to measure the body temperature automatically, without a user activity or sleep having to be interrupted, and without body movements of the user being required.

What is claimed is:

1. An ear thermometer, comprising:
a housing;
an infrared sensor configured to record body temperature data;
a control unit;
a power supply unit located in the housing; and
a wireless communication interface configured to transmit the recorded body temperature data to a base station.

2. The ear thermometer as claimed in claim 1, wherein the ear thermometer has an optical waveguide connected to the infrared sensor.

3. The ear thermometer as claimed in claim 1, wherein the ear thermometer is integrated into a hearing aid.

4. The ear thermometer as claimed in claim 1, wherein the infrared sensor is a thermopile.

5. The ear thermometer as claimed in claim 1, wherein the wireless communication interface is a WLAN or Bluetooth interface.

6. The ear thermometer as claimed in claim 1, wherein the control unit is designed to convert a measurement value from the infrared sensor into a body temperature value.

7. A system, comprising:
a base station having a first wireless communication interface, a base control unit and a human-machine interface; and
an ear thermometer including a housing, an infrared sensor configured to record body temperature data, a control unit, a power supply unit located in the housing, and a second wireless communication interface configured to transmit the recorded body temperature data to the first wireless communication interface of the base station.

8. The system as claimed in claim 7, wherein the base station has a data storage device.

9. The system as claimed in claim 8, wherein the base station has a clock.

10. A method for measuring the body temperature of a human with an ear thermometer having an infrared sensor and a base station, comprising:
a) measuring an infrared sensor measurement value from the infrared sensor;
b) converting the infrared sensor measurement value into a temperature measurement value;
c) wirelessly transmitting the infrared sensor measurement value or the temperature measurement value to a base station; and
d) displaying and storing the temperature measurement value.

11. The method as claimed in claim 10, wherein the measurement takes place according to a prescribed timetable.

12. The method as claimed in claim 10, wherein a warning signal is emitted if there is a fault in the communication between ear thermometer and base station.
